(19) United States
(12) Patent Application Publication
(10) Pub. No.: US 2005/0130841 A1
(43) Pub. Date: Jun. 16, 2005

(54) Hydrolyzed urea fertilizer, fungicide and insecticide

(76) Inventor: David H. Blount, San Diego, CA (US)

Correspondence Address: David H. Blount, 6728 Del Cerro Blvd., San Diego, CA, 92120, US

(21) Appl. No.: 10/974,996

(22) Filed: Oct. 28, 2004

Related U.S. Application Data
(63) Continuation-in-part of application No. 10/922,291, filed on Aug. 20, 2004.
Application No. 10/922,291 is a continuation-in-part of application No. 09/941,402, filed on Aug. 30, 2001, now abandoned.
Application No. 09/941,402 is a continuation-in-part of application No. 09/532,646, filed on Mar. 22, 2000, now Pat. No. 6,348,526.
Application No. 09/532,646 is a continuation-in-part of application No. 08/801,776, filed on Feb. 14, 1997, now Pat. No. 5,788,915.
Application No. 08/801,776 is a continuation-in-part of application No. 08/723,779, filed on Sep. 30, 1996, now Pat. No. 5,854,309.

(51) Int. Cl. C05G 3/00

(52) U.S. Cl. 504/101

(57) ABSTRACT

Fertilizer, fungicide and insecticide compositions are produced by the process of this invention. The partially hydrolyzed urea are produced by heating urea with a limited amount of water and continue heating until water reacts with the urea. The partially hydrolyzed urea may be used alone or may be mixed with or reacted with salt forming compounds and mixed with a fillers to produce a partially hydrolyzed urea composition which is a fast acting and a long acting fertilizer. The partially hydrolyzed urea salts of phosphorus, boron or sulfur containing compounds with or with fillers may also be used as the insecticide, fungicide and fertilizer compound in this invention.

This application is a continuation in part of the application Ser. No. 10/922,291 filed Aug. 20, 2004, which is a continuation in part of Ser. No. 09/941,402 filed on Aug. 30, 2001, which is a continuation in part of Ser. No. 09/532,646 filed Mar. 22, 2000 now U.S. Pat. No. 6,348,526, which is a continuation in part of Ser. No. 08/801,776, filed Feb. 14, 1997, now U.S. Pat. No. 5,788,915 which is a continuation in part of Ser. No. 08/723,779, filed Sep. 30, 1996 now U.S. Pat. No. 5,854,309.

### FIELD

The invention concerns urea being partially hydrolyzed and it's salts. The invention also concerns their preparation and use. The partially hydrolyzed urea compounds are useful to produce insecticide, fungicide and rapid acting and long acting fertilizer products, and may be reacted with potassium and/or phosphorus to produce other fertilizer, fungicide and insecticide compounds.

### BACKGROUND

The heating of urea to produce urea condensation compounds, such as biuret and a mixture of cyanuric acid and cyamelide, is known in the arts, but the partially hydrolysis of urea to produce improved short acting and long acting fertilizer, fungicides and insecticide compounds is novel. U.S. Pat. No. 5,788,915 utilizes partially hydrolyzed condensated urea as a flame retardant. The partially hydrolyzed urea compounds and their phosphorus and/or sulfate salts and/or may be used as a fungicide, insecticide and a rapid acting and long acting fertilizer compounds.

What is lacking and what is needed are useful inexpensive partially hydrolyzed urea with a plurality of nitrogen moieties. The partially hydrolyzed urea compounds and/or their salts of this invention are novel fungicides, insecticide and rapid acting and long acting fertilizer compounds. What is additionally lacking are compositions having such partially hydrolyzed urea compounds and/or their salts employed therein. The urea with a limited amount of water is heated at a low enough temperature to avoid urea reacting with itself to produce biuret or other condensates.

### SUMMARY

In one aspect, the invention comprises partially hydrolyzed urea compounds and their salts. Another aspect of the invention is a process to prepare partially hydrolyzed urea compound and/or their salts comprising serially contacting, heating and reacting:
(A) urea;
(B) water;
(C) salt forming compound
(D) filler
   under conditions sufficient to prepare the partially hydrolyzed urea compounds. The urea is first gradually added to a limited amount of heated water which reacts with —NH₂ radical and as the urea melts in the water more urea is added which reacts with the water thereby producing partially hydrolyzed urea. After the urea has been partially hydrolyzed and cooled more water is added to produce an aqueous solution with the desired nitrogen content. A partially hydrolyzed urea salt is produced by reacting an acidic and/or a basic salt forming compound with the partially hydrolyzed urea. A filler may be added to the partially hydrolyzed urea or it's salt to produce a composition. The pH of the partially hydrolyzed urea salts maybe adjusted to have a pH of 1.5-8.5 by utilizing an acidic salt forming compound or a basic salt forming compound or buffering compound such as organic acid.

In another aspect, the invention comprises partially hydrolyzed urea salt of phosphorus and/or sulfate and/or boron containing compound and a process to prepare a partially hydrolyzed urea salt of a phosphorus and/or sulfate and or boron containing compound employing phosphorus and/or sulfur and/or boron containing compound that will react with the partially hydrolyzed urea compound under conditions sufficient to prepare the partially hydrolyzed urea salt of a phosphorus and/or sulfur and/or boron containing compound, and a process to prepare a partially hydrolyzed urea salts of a phosphorus and/or a sulfur and/or a boron containing compound comprising serially contacting, heating and reacting:
(A) urea;
(B) water; then
(C) phosphorus and/or sulfur and/or boron containing compound that react with a partially hydrolyzed urea compound.
(D) filler
   component A and B are first heated and reacted by first gradually adding urea to a limited amount of heated water to produce a partially hydrolyzed urea compound and heated up to 120 degree C. for 0.1 to 3 hours, then component C is added and reacted at ambient pressure, heated up to 120 degrees C. for 0.1 to 3 hours then component D is added and mixed. The partially hydrolyzed urea salts are usually diluted with water in the ratio of 1:40 to 1:600 and pH is adjusted to be acceptable for foliage uptake of phosphorus.

An additional aspect of the invention is use of the partially hydrolyzed urea compounds, partially hydrolyzed urea salts of phosphorus and/or sulfur and/or boron compounds and partially hydrolyzed urea composition as an insecticide, fungicide and a rapid acting and long acting fertilizer compounds. The fertilizer, fungicide and insecticide compositions may consist of partially hydrolyzed urea compound and/or a partially hydrolyzed urea salt of a phosphorus and/or sulfur and/or boron containing compound and fillers.

The fungicide, insecticide and fertilizer compounds of this invention are produced by gradually adding 100 parts by weight of urea (Component A) to 10 to 40 parts by weight of heated water (Component B) with a temperature of 100 degree C. and up to about 120 degree C. at ambient pressure for 0.1-3 hrs. In order to increase resistant of plants to aphids and fungus addition compounds may be added or reacted with the fertilizer such as, potassium, phosphorus acidic compounds, or organic phosphorus compounds that will react with a partially hydrolyzed urea or its salts and mixtures thereof is added to the melted partially hydrolyzed urea compound mixed and/or reacted. The partially hydrolyzed urea and its salts are useful as fungicides and insecticide but may be enhance by reacting boron oxyacid or their salts with the partially hydrolyzed urea and utilized as a fungicide and an insecticide especially for use to kill ants termites and cockroaches.

The partially hydrolyzed urea compound is hydrolyzed by reacting it's —NH₂ radical with water to produce —COONH₄ radicals thereby producing partially hydrolyzed urea compounds with fast release and slow release nitrogen containing radicals such as —NH² and —COOH₄ radicals. Excess heat must be avoided to prevent production of urea condensates such as biuret.

Fertilizer maybe added to the plants foliage in a dilute form or may be added to the soil of crops. Many elements are essentially to the health and growth of plants. Nitrogen, phosphorus and potassium are provided in the greatest quantity. The phosphorus may be in any suitable form and contain 3-5 valences. Phosphorus with 34 valences or a combination of phosphorus with 34 valences and phosphorus with 5 valences may be used in a dilute aqueous solution to spray on plant foliage and is helpful to the plant to resist aphides, fungus, dryrot, fungus, pest, etc. The aqueous partially hydrolyzed urea salts may be produced in a concentrated form which stays in solution and is essentially clear which can be diluted with water and applied on plant foliage or to the plants soil. The phosphorus with a valence of 3-4 is less likely to support the growth of algae

### Component A

Urea is utilized as component A and may be in the form of a powder, crystals or a solid. Any suitable urea may be utilized that will react with a limited amount of water to be partially hydrolyzed. Urea is utilized in the amount of 50-100 parts by weight.

### Component B

Water is utilized in the amount of 10 to 40 parts by weight. Water may be added first then heated before the urea is added. Water is also utilized to produce an aqueous solution of the partially hydrolyzed urea that contains the desirable amount of nitrogen.

### Component C

Any suitable basic or acidic salt forming compound may be utilized in this invention. Suitable salt forming compound are organic and inorganic phosphorus acids, boron oxyacids or sulfuric acids and their salts. These acidic components are compounds such, for example, acids or salts, or their derivatives of sulfur, boron and phosphorus, such as, phosphorus oxyacids, boron oxyacids, sulfur oxyacids, boron-phosphates, phosphates, phosphorous acid, hypophosphorous acid, polyphosphorous acid, polyhypophosphorus acid, ammonium salts of phosphorous acids, polyphosphates of ammonia, alkali metal hydrogen phosphates, alkaline earth metal hydrogen phosphates, phosphates of amines, polyamines, amino compounds, thioureas and alkyanolamines, boric acid and its salts and their derivatives, organic phosphorus compounds and their salts, halogenated organic phosphorus compounds, their salts and their derivatives, organic acids, suitable organic acids have the formula R—COOH where R is hydrogen or a carbon containing molecule or group of molecules may also be used for this purpose and the preferred organic acids are dicarboxylic and tricarboxylic acids. The salt forming compounds may be used in quantities of 0 to 400 parts by weight. When the salt forming compound is used it may be used in the amount of 1 to 400 parts by weight based.

The nitrogen and potassium containing salts of phosphorus acids are the preferred salts for use as a fertilizer. The nitrogen containing salts of boron-phosphate is the preferred salts for use as an insecticide and as a fungicide. The basic urea condensate salt of phosphorus compounds are produced by contacting the partially hydrolyzed urea compounds with a phosphorus oxyacid compound that will react with partially hydrolyzed urea compound, under conditions sufficient to prepare a partially hydrolyzed urea salt of a phosphorus oxyacid then a basic potassium compound may be reacted with the acidic salt to produce a potassium partially hydrated urea salt of phosphorus oxyacid. Suitable inorganic phosphorus compounds include, but not limited to, phosphoric acid, pyrophosphoric acid, triphosphoric acid, metaphosphoric acid, phosphorous acid, hydrophosphorous acid, phosphinic acid, phosphinous acid, phosphine oxide, phosphorus trihalides, phosphorus oxyhalides, phosphorus oxide, mono-metal hydrogen phosphates, ammonia dihydrogen phosphate, bromated phosphates, alkali metal dihydrogen phosphate and halogenated phosphate-phosphite and their halides and acids. organic phosphorus compounds include, but not limited to, alkyl, cyclic, aryl and alkyl-aryl phosphorus compounds, such as, alkylchlorophosphines, alkyl phosphines, alkyl phosphites, dialkyl hydrogen phosphites, dialkyl alkyl phosphonates, trialkyl phosphites, organic acid phosphates, organic diphosphonate esters, aryl phosphites, aryl hydrogen phosphates, halogenated phosphonates esters and mixtures thereof. Partially hydrolyzed urea borates may be produced by contacting boric acid and partially hydrolyzed urea condensate compound under conditions sufficient to prepare the partially hydrolyzed urea borates. Partially hydrolyzed urea salt of boron-phosphates may be produced by contacting boron-phosphates and partially hydrolyzed urea compounds under conditions sufficient to prepare partially hydrolyzed urea salt of boron-phosphate compounds. The salt forming phosphorus containing compounds will react with the partially hydrolyzed urea condensate compounds to form a partially hydrolyzed urea condensate salt of a phosphorus containing compound. The phosphorus containing compounds are the preferred acidic salt forming compounds.

Any suitable basic salt forming compounds may be utilized in this invention. The potassium basic salt forming compounds are preferred. Suitable basic salt forming compounds include but not limited to alkali metal containing compounds, alkaline earth metal containing compounds, ammonia, amines, polyamines, amino compounds and mixtures thereof. The basic salt forming compound may react with the partially hydrolyzed urea or with its salts. Mixtures of the acidic and basic salt forming compounds may be utilized. The acid and/or basic salt forming compounds are utilized in the amount of 0-400 parts by weight. When they are utilized the are utilized in the amount of 1400 parts by weight.

### Component D

Any suitable filler or bait may be used in this invention. The fillers may be inorganic substances, such as, alkali metal compounds, lime, alkaline earth metal silicates, metal silicates, silica, metals, oxides, carbonates, sulfates, phosphates, borates and organic matter such as cellulose materials. They may be organic substances, such as, amino compounds, such as urea, melamine, dicyandiamide, and other cyanuric derivatives or their formaldehyde resins, aminophosphates, amino salts of organic phosphates, and mixtures thereof. The fillers may also be substances that act as bait for insects such as carbohydrates, such as sugar, syrups, corn meal flour, etc., vegetable and fatty oils, and cellulose materials. Fillers may be added in the amount of 0 to 300 parts by weight. When the filler is added it may be added in the amount of 1 to 300 parts by weight. Suitable organic nitrogen containing compounds may be an aliphatic, aromatic, cyclic, aliphatic-aromatic or aliphatic-cyclic compound such as, but not limited to, urea, urea derivatives for example, O-alkylureas, amino compounds, for example, melamine, melamine cyanurate, dicyandiamide, biuret, cyanuric acid, cyamelide, guanidine, cyanoguanidine, ammeline and aminoguanidine, guanidine carbonate, ammonium carbonate, alkyl carbamates, alkyl isocyanates, polyisocyanates, sulfamic acid, ammonium sulfamate, amines, polyamines, thioureas, alkylanolamine, polyamides, amino hydrogen phosphates, amidines, amides, aldimines, ketimines, amino carbonates, aminoborates, amino sulfates, thiourea derivatives, alkylanolamines, nitriles, etc., and mixtures thereof. Suitable inorganic nitrogen containing compounds such as, but not limited to, ammonium phosphate, diammonium phosphate, ammonium polyphosphate, ammonium borate, ammonium hydrogen sulfate, quaternary ammonium salts, ammonium bicarbonate, ammonium carbonate, ammonium carbamate etc. and mixtures thereof. The amino compounds are the preferred nitrogen containing compound. The filler may be utilized in the amount of 0-300 parts by weight. When they are utilized they are used in the amount of 1-300 parts by weight.

### Illustrative Embodiments

In general, the partially hydrolyzed urea compounds are compounds which are produced by heating urea in a limited amount of water. The partially hydrolyzed urea may be produced by any suitable method, the water maybe added first, heated, then urea added, further heated and reacted with the water or the urea maybe added then water is added and heated up to 120 degrees C. for 0.1 to 3 hours usually at ambient pressure by elevated or reduced pressure may be used thereby producing partially hydrolyzed urea. Over heating of the urea in the limited amount of water should be avoided to prevent production of urea condensates because some fruits and vegetables are damages by biuret.

These urea is converted to a partially hydrolyzed urea compound by reacting water with the —NH₂ radical of this compound to form NH₄OOC— radicals on the partially hydrolyzed urea compound.

The partially hydrolyzed urea compound of this invention is preferable produced by heating 10 to 40 parts by weight of water to about 100 degree C. then slowly adding 100 parts by weight of urea and continue heating the mixture at 100 to 120 degree C. for 0.1 to three hours at ambient pressure or any suitable pressure such as 500 psi. The partially hydrolyzed urea compounds may be cooled then ground into a powder or water may be added to form an aqueous solution of this compound. The partially hydrolyzed urea may be reacted with a salt forming compound by mixing and/or heating this mixture to up to 120 degree C. for 0.1 to 3 hours at ambient pressure. A basic salt forming compound may be added to and reacted with the salt of the partially hydrolyzed urea condensate. The basic salt forming compound will usually react with the salt of the partially hydrolyzed urea or the —COONH₄ radicals at ambient temperature but the temperature may be elevated up to 120 degree C. The mineral acids will react with the partially hydrolyzed urea condensate without heating but may be further reacted by heating thereby producing a salt of partially hydrolyzed urea which may be cooled then ground into a powder or added to water to form an aqueous solution. A combination of the acidic and basic salt forming compounds may be utilized to adjust the pH preferably in the range of pH 5-8.5. Fillers may be added to this compound while it is melted or to the powder form or added to the aqueous solution to form a partially hydrolyzed urea composition.

### DESCRIPTION OF PREFERRED EXAMPLES

The present invention will now be explained herein-after by way of a few examples and comparative examples, these examples setting, however, no limits to this invention. Parts and percentages are by weight, unless otherwise indicated.

### Example 1

10 parts by weight of water is heated to about 100 degrees C. at ambient pressure then a total of 90 parts by weight of urea is slowly added in small portions to the hot water, at ambient pressure, and heated up to 120 degree C. for 5 minutes thereby producing a fertilizer, fungicide and insecticide compound, partially hydrolyzed urea. Part of the liquid partially hydrolyzed urea is cooled then ground into a granules or powder and contains 44% nitrogen. The remaining partially hydrolyzed urea compound is added to water to form an aqueous solution containing 20% nitrogen.

### Example 2

Example 1 is modified wherein the hot liquid partially hydrolyzed urea compound is heated up to 105-120 degrees C. for 20 minutes at ambient pressure. The hot liquid partially hydrolyzed urea compound is cooled then ground into a powder which contains about 40% nitrogen.

### Example 3

About 100 parts by weight of urea beads are slowly added to 30 parts by weight of hot water at ambient pressure then heated to 105 to 120 degrees C., and heated for 30 minutes thereby producing a fertilizer, fungicide and insecticide compound, partially hydrolyzed urea compound, which is cooled by spraying into a flow of air or cooled then pulverized into a powder which contains about 44% nitrogen.

### Example 4

About 100 parts by weight of urea, is mixed with 30 parts by weight of hot water then heated to above the melting point of urea in water to 120 degrees C. for 30 minutes at ambient pressure, thereby producing a fertilizer, fungicide and insecticide compound, partially hydrolyzed urea compound, which is pulverized into granules containing 41% nitrogen.

### Example 5

100 parts by weight of urea is slowly mixed with 20 parts by weight of hot water then heated to 120 degree C. for 30 minutes at ambient pressure, thereby producing a fertilizer, fungicide and insecticide compound, partially hydrolyzed urea compound which is pulverized into a powder containing 41% nitrogen.

### Example 6

100 parts by weight of urea and 25 parts by weight of water are mixed then heated to 110 to 120 degrees C. for 15 minutes at ambient pressure thereby producing a partially hydrolyzed urea compound. The cooled fertilizer, fungicide and insecticide compound, partially hydrolyzed urea compound, is ground into granules or a powder containing 42% nitrogen.

### Example 7

Example 6 is modified wherein 50 parts by weight of phosphoric acid is added to the hot partially hydrolyzed urea compound, mixed and reacted at ambient pressure thereby producing a fertilizer, fungicide and insecticide compound, partially hydrolyzed urea salt of phosphoric acid which is cooled and ground into a powder.

### Example 8

Example 7 is modified wherein another salt forming compound is used in place of phosphoric acid and selected from the list below thereby producing a partially hydrolyzed urea salt of the salt forming compound listed below:

a) phosphorus acid
b) sulfuric acid
c) boric acid
d) dimethyl methyl phosphonate
e) polyphosphoric acid
f) pyrophosphoric acid
g) hypophosphoric acid
h) phosphinous acid
i) phosphinic acid
j) phosphine oxide
k) potassium hydrogen phosphate
l) ammonium hydrogen phosphate
m) potassium salt of hydrogen phosphorous acid
n) urea hydrogen phosphate
o) mixtures of the above.
p) phosphorous acid + citrate acid

### Example 9

About 10 parts by weight of the partially hydrolyzed urea compound of example 4 is mixed with 35 parts by weight of phosphorous acid then heated to above the melting point of the partially hydrolyzed urea compound for about 30 minutes at ambient pressure, thereby producing a partially hydrolyzed urea salt of phosphorous acid then an aqueous solution containing 50% potassium hydroxide is slowly added until the solution has a pH of 6.5 thereby producing a fertilizer, fungicide and insecticide compound, potassium partially hydrolyzed urea salt of phosphorous acid.

### Example 10

Example 9 is modified by first reacting 5 parts by weight of boric acid with the 25 parts by weight of phosphoric acid thereby producing a fertilizer, fungicide and insecticide compound, boron-phosphate condensation compound and utilizing it in place of the phosphorous acid in example 9.

### Example 11

Example 9 is modified wherein another phosphorus containing compound is utilized in place of phosphorous acid and selected from the list below:
a) pyrophosphoric acid
b) phosphinic acid
c) phosphorus trichloride
d) phosphorus oxytrichloride
e) phosphorus oxide
f) ammonium dihydrogen phosphate
g) mono-aluminum phosphate
h) dimethyl methyl phosphonate (DMMP)
i) dimethyl hydrogen phosphite
j) phenyl acid phosphate
k) methylchlorophosphine
l) phosphorus
m) phosphorus thiochloride
n) tris(2-chloropropyl) phosphate
o) triphenyl phosphite
p) tris 2-chloroethyl phosphite
q) triethyl phosphite
r) urea dihydrogen phosphate
s) diethyl phosphite
t) trimethyl phosphite
u) dibutyl pyrophosphoric acid
v) melamine hydrogen boron-phosphate
x) hypophosphorous acid
y) methyl amine salt of phosphoric acid
z) O,O-dimethyl hydrogen dithiophosphate

### Example 12

Example 3 is modified wherein a phosphorus containing compound selected from the list in example 11 is added to the urea before it is added to the heated water thereby producing a mixture of urea salt of a phosphorus containing compound and partially hydrolyzed urea salt of a phosphorus containing compound. The mixture is ground into a fine powder thereby producing a fungicide, insecticide and fertilizer.

### Example 13

Example 9 is modified wherein 20 parts by weight of powdered dimelamine phosphate is added to and mixed in with the melted partially hydrolyzed urea compound thereby producing a fungicide, insecticide and fertilizer amino phosphate composition which is cooled and ground into a powder.

### Example 14

Example 6 is modified wherein 25 parts by weight of melamine hydrogen phosphate powder is added to and mixed in with the melted partially hydrolyzed urea compound thereby producing a partially hydrolyzed urea phosphate. 10 parts by weight of ammonium phosphate powder is mixed in the partially hydrolyzed urea phosphate thereby producing a fertilizer, fungicide and insecticide compound, partially hydrolyzed urea phosphate composition.

### Example 15

20 parts by weight of urea and 3 parts by weight of water are mixed then heated to 105 degree C., then continued to heat for 10 minutes at 105 degree C. and at ambient pressure, thereby producing partially hydrolyzed urea, then 100 parts by weight of phosphorous acid flakes are slowly added and then heated to about 100 degree C. for 15 minutes at ambient pressure thereby producing a partially hydrolyzed urea salt of phosphorous acid. The partially hydrolyzed urea salt of phosphorous acid is reacted with a 50% aqueous potassium hydroxide solution by slowly adding the aqueous potassium hydroxide solution to the partially hydrolyzed urea salt of phosphorous acid until a pH 6.5 is obtained thereby producing a fertilizer, fungicide and insecticide compound, potassium partially hydrolyzed urea salt of phosphorous acid.

### Example 16

Example 15 was modified wherein aqueous ammonia or anhydrous ammonia was utilized instead of the potassium hydroxide thereby producing a fertilizer, fungicide and insecticide compound, ammonium partially hydrolyzed urea salt of phosphorous acid composition.

### Example 17

100 parts by weight of urea, 20 parts by weight of water and 30 parts by weight of melamine phosphate are mixed then heated above the melting point of urea in water and up to 120 degree C. for 40 minutes at ambient pressure thereby producing a fertilizer, fungicide and insecticide compound, partially hydrolyzed urea melamine phosphate composition. After cooling it is ground into a powder.

### Example 18

Example 1 is modified wherein 20 parts by weight of a phosphorus salt forming compound selected from the list below is added to and reacted with the partially hydrolyzed urea compound;
a) phosphoric acid
b) pyrophosphoric acid
c) dimethyl methyl phosphonate (DMMP)
d) dimethyl hydrogen phosphite
e) trimethyl phosphite
f) phenyl acid phosphate
g) phosphorus trichloride
h) phosphinic acid
i) phosphorus oxytrichloride
j) ammonium dihydrogen phosphate
k) dimethyl phosphoric acid
l) diethyl ethyl phosphonate
m) magnesium hydrogen phosphate
n) mono aluminum phosphate

### Example 19

Example 4 is modified wherein 20 parts by weight of a powdered filler selected from the list below is mixed with the powdered partially hydrolyzed urea compound thereby producing a partially hydrolyzed urea composition:
a) hydrated aluminum oxide powder
b) hydrated sodium silicate powder
c) melamine
d) dicyandiamide
e) urea
f) melamine phosphate
g) melamine borate
h) ammonium phosphate
i) ammonium pyrophosphate
j) ammonium carbonate
k) ammonium borate
l) ammonium sulfamate
m) guanidine
n) guanidine carbonate
o) urea phosphate
p) silica powder
q) phenol-formaldehyde resin powder
r) aluminum phosphate
s) thiourea
t) diatomaceous earth
u) expandable graphite
v) melamine salt of DMMP
r) ammonium sulfate
s) magnesium chloride
t) antimony trioxide
u) boron-phosphate powder
w) melamine boron-phosphate powder
x) ammonium boron-phosphate powder

### Example 20

Example 17 is modified wherein another amino phosphorus containing compounds is selected from the list below and utilized in place of melamine phosphate:
a) dimelamine phosphate
b) dicyandiamide phosphate
c) urea dihydrogen phosphate
d) guanidine phosphate
e) aminoguanidine phosphate
f) diethyltriamine urea phosphate
g) melamine salt of dimethyl methyl phosphonate
h) melamine salt of dimethyl hydrogen phosphite
i) methylamine melamine phosphoric acid
j) methyl carbamate salt of phosphoric acid
k) melamine salt of boron-hydrogen phosphate
l) O-methyl urea phosphate
m) urea salt of boron-phosphate
n) urea-formaldehyde phosphate
o) aminophenol phosphate
p) ammonium urea phosphate
q) ammonium melamine phosphate
r) melamine salt of trimethyl phosphite
s) melamine salt of phenyl acid phosphate

### Example 21

Example 5 is modified wherein the partially hydrolyzed urea compound in the amount of 10 parts by weight is heated up to 120 degree C. with a mixture of 20 parts by weight of phosphorous acid and 30 parts by weight of phosphoric acid thereby producing a partially hydrolyzed urea phosphorus salt then an aqueous solution containing 50% potassium hydroxide is slowly added to the partially hydrolyzed urea phosphorus until the pH is 6.5.

### Example 22

20 parts by weight of the partially hydrolyzed urea produce in example 1 is added to 100 parts by weight of water then 20 parts by weight of monoammonium phosphite and 20 parts by weight of diammonium phosphite are dissolve into the water. The pH is then adjusted to a pH 7 by adding ammonia hydroxide thereby producing a fertilizer, fungicide and insecticide. This mixture is diluted with water to form a 1% aqueous solution then sprayed on the leaves of plants.

### Example 23

25 parts by weight of phosphoric acid (85%) is reacted with the partially hydrolyzed urea compound selected from the list below thereby producing a partially hydrolyzed urea salt of phosphoric acid:
1. 55 parts by weight of partially hydrolyzed urea compound of Example 2.
2. 47 parts by weight of partially hydrolyzed urea compound of Example 4.
3. 45 parts by weight of partially hydrolyzed urea compound of example 5.

### Example 24

A dozen of similar tomato plants of about 4-5 inches tall was planted in a garden then around 4 of the plants 50 grams of the partially hydrolyzed urea produced in example 1 was placed around the plants. 50 grams of fertilizer containing 16% nitrogen was placed around 4 other tomato plants. 4 of the plants was not fertilized. The plants were watered every other day using the same amount of water. In 10 days the tomato plants that was fertilized grew about 34 inches taller than the unfertilized plants. After 30 days the plants fertilized with the partially hydrolyzed urea continued to grow at a faster rate than the other plants and were taller, had more branches and was wider than the other plants. These plants also produced more tomatoes than the other plants.

### Example 25

Example 24 is modified wherein another partially hydrolyzed urea also produced the same growth results and is used in place of partially hydrolyzed urea and selected from the list below:
1. Partially hydrolyzed urea of example 2
2. Partially hydrolyzed urea of example 4
3. Partially hydrolyzed urea of example 5
4. Partially hydrolyzed urea of example 6

### Example 26

Example 24 is modified obtaining the same good results using a partially hydrolyzed urea salt of phosphorus oxyacid selected from the list below:
1. Partially hydrolyzed urea salt of phosphorus oxyacid of example 9.
2. Partially hydrolyzed urea salt of phosphorus oxyacid of example 11a.
3. Partially hydrolyzed urea salt of phosphorus oxyacid of example 11h.
4. Partially hydrolyzed urea salt of phosphorus oxyacid of example 11b.

### Example 27

3 inch pads covered with peanut butter diluted with peanut oil and containing 30 percent partially hydrolyzed urea produced in example 1 was placed around 10 fire ant mounds. The mound was examined 3 days later and the fire ants had left 6 of the mounds. More pads containing the peanut butter was placed around 4 mounds containing ant and with in 3 days 2 of the mounds were free of ants.

### Example 28

A lid containing corn syrup which contained 10% partially hydrolyzed urea salt of boron-phosphate produced in example 10 was place near an ant mound which contains sweet eating ants. The ants in the ant mound disappeared in three days.

### Example 29

The perimeter around a cottage contains various plants which had a layer of pine needles and leaves around the plants. There was a lot of cockroaches under the pine needles and the plants were losing leaves and were in poor shape. On the north side of the house about 100 grams of partially hydrolyzed urea produced in example 10 was placed around each plant. On the south side of the cottage 100 grams of urea salt of phosphoric acid produced in example 12 and containing 5% sodium borate was placed around the plants. On the east side of the cottage 100 grams of partially hydrolyzed urea produced in Example 1 with 5% ammonium borate was placed around the plants. On the west side of the cottage 100 grams of partially hydrolyzed urea salt of phosphoric acid was placed around the plants. The plants were then watered every 3^{rd} day. After one week each side of the house was examined for cockroaches by checking under the pine straws. The cockroaches had disappeared from all around the plants.

After about 10 days new leaf buds began to show on the plants around the cottage and within 3 week the plants had new leaves and began to grow. After 3 month the plants continue to grow and develop new leaves and branches.

### Example 30

About 1 dozen of thin wood chips were sprayed with a 20% aqueous solution of partially hydrolyzed urea produced in example 1, another dozen of wood chips were sprayed with a 20% aqueous solution of partially hydrolyzed urea salt of phosphoric acid, and another dozen of thin wood chips sprayed with a 20% aqueous solution of partially hydrolyzed urea condensate containing 5% zinc borate were buried about 4 inches under the ground in a moist area near the house. These wood chips were dug up after being in the ground for 10 months. The chips still contain some the partially hydrolyzed urea. The chips were examined for any dry rot, termite infestation and fungus and none was found.

### Example 31

Various plants were collected from a nursery which were in very poor condition and were to be destroyed. These plants were watered with a 10% solution of partially hydrated urea then watered daily. With in 10 days the plants begin to grow buds and new leaves. The plants continue to grow for 3 month without any addition of fertilizer and remained in very good condition.

### Example 32

The leaves of a peach tree contained aphides was sprayed with a 1% aqueous solution of potassium partially hydrolyzed urea salt of phosphorous acid produced in example 15. The leaves were examined and found that the outer layer of the leaves had thickened and acted as a protection against aphides.

### Example 33

A board of fir lumber which had a 1″×6″ area of dryrot and had termite was sprayed with an aqueous solution containing 20% aqueous solution of partially hydrolyzed urea compound produced in example 3. The lumber was placed back into the termite containing firewood then it was re-examined after 10 months the dryrot area had not gotten any larger and there is no sign of new termite damage.

### Example 34

Several fir board was sprayed with an aqueous solution of partially hydrolyzed urea salt of phosphoric acid then placed in a fire wood pile which contained termites, The boards were examined after 6 months and 1 year and no termite damage or dryrot was found.

### Example 35

An 8′×8′ tool shed was infested with cockroaches. The floor around the inside walls was sprinkled with partially hydrolyzed urea salt of boron-phosphate powder. One week later all the cockroaches had disappeared, and several months later they were still gone.

### Example 36

A plant Pathologist did fungicide studies on the fungicide produced in example 15. Gerber daisy infected with the pathogen Oidium sp. was placed next to uninfected plants then the plants were wet by spraying with the potassium urea salt of phosphorous acid which was diluted to 64 oz per 100 gallons of water. All treatments were applied as a foliar spray with a hand pump spray bottle and applications were made weekly for three weeks. It was concluded that it exhibited good levels of prevention of the pathogen in this test.

### Example 37

A three acre area of farm land where grass was being grown was divided into 3 areas of the same size. One area was left unfertilized, one area was fertilized with aqueous urea and the other area was fertilized with aqueous partially hydrolyzed urea and the same of amount of nitrogen was sprayed on the two areas. The same amount of water was applied to each area. For the first month the two fertilized areas grass grew faster and was greener than the unfertilized area's grass. After 1 month the unfertilized and the area's grass ferterilized with the urea was growing very little and was turning brown-green in color. The area fertilized with the partially hydrolyzed urea continued to grow more than the other two areas and remained bright green in color for another 2 months.

### Example

Four rows of corn about 200 feet long was fertilized, two rows with aqueous urea and two rows with aqueous partially hydrolyzed. The same amount of nitrogen was plowed into each row. The rows was watered by a limited amount of rain. The corn on the rows was harvested and compared. The yield on the two rows that was fertilized with the partially hydrolyzed urea had a 25% better yield of corn and the corn kernels on these corn cobs produced about 20% more kernals the corn fertilized by urea. The corn produced in the rows fertilized with the aqueous partially hydrolyzed urea had much less damage to the kernels and much less damage to the corn silk by insects and fungus.

### CONCLUSION

It is surprising that the partial hydrolysis of the urea compounds has very good insecticide, fungicide and fertilizing properties and had long lasting nitrogen. The addition of salt forming compounds such as phosphoric acid and potassium phosphate increase the fertilizing immediate and prolonged effect and forms fungus and aphides protection. The addition of salt forming compounds such as phosphoric acid, boric acid and borates increase its effectiveness against insect such as ants, termites and cockroaches and against fungus.

It will be appreciated by those skilled in the Arts that changes and modifications of the preferred embodiment can be made without departing from the spirit and broader aspects of the invention as set forth in the appended claims.

1. An insecticide, fungicide and fertilizer produced by the process comprising of mixing, heating and reacting the following components:
(A) urea, 50-100 parts by weight;
(B) water, 10 to 40 parts by weight;
(C) Salt forming compounds, 0 to 400 parts by weight
(D) filler, 0 to 300 parts by weight
components A and B are first mixed, then heated to 100 to 120 degree C. at ambient pressure for 0.1 to 3 hours and reacted to produce a partially hydrolyzed urea,
then component C is added, mixed, heated to 100 to 120 degrees C. at ambient pressure for 0.1 to 3 hours and reacted, thereby producing a partially hydrolyzed urea salt, then component D is added and mixed thereby producing a partially hydrolyzed urea composition.

2. The insecticide, fungicide and fertilizer composition of claim 1 wherein the salt forming compounds are selected from the group consisting of phosphorus containing compounds, boron containing compounds, boron-phosphate containing compounds and sulfur containing compounds, alkali metal compounds, alkaline earth metal compounds, metal compounds, ammonia, amines, polyamines and mixtures thereof in an amount of 0 to 400 parts by weight.

3. The insecticide, fungicide and fertilizer composition of claim 1 wherein the filler is selected from the group consisting of urea, melamine, dicyandiamide, melamine cyanurate, amino phosphates, aminopolyphosphates, aminoplasts, phenoplasts, powdered synthetic resins, sawdust, carbohydrates, ammonium sulfate, ammonium phosphate, amino phosphates, potassium phosphate, amino sulfates, silica, diatomaceous earth, alkali metal silicates, alkaline earth metal silicates, metals, metal silicates, oxides, carbonates, sulphates, phosphates and borates, potassium hydrogen phosphate and mixtures thereof, in an amount 0 to 300 parts by weight.

4. The insecticide, fungicide and fertilizer composition of claim 1 wherein the partially hydrolyzed urea salt is a partially hydrolyzed urea salt of phosphorus oxyacid.

5. The insecticide, fungicide and fertilizer composition of claim 1 wherein the partially hydrolyzed urea is a partially hydrolyzed urea salt of an organic phosphorus compound.

6. The insecticide, fungicide and fertilizer composition of claim 1 wherein the phosphorus containing compound is an acidic phosphorus compound.

7. The insecticide, fungicide and fertilizer composition of claim 5 wherein the phosphorus containing compound is an organic phosphite.

8. The insecticide, fungicide and fertilizer composition of claim 1 wherein the partially hydrolyzed urea composition is partially hydrolyzed urea sulfate.

9. The insecticide, fungicide and fertilizer composition of claims wherein the organic phosphorus compound is organic phosphorus compound which has a valence of 3.

10. The insecticide, fungicide and fertilizer composition of claim 1 wherein the water is added to the urea before heating.

11. The insecticide, fungicide and fertilizer composition of claim 1 wherein the salt forming compounds are phosphorous acid and potassium hydroxide.

12. A method for producing insecticide, fungicide and fertilizer compositions consisting of partially hydrolyzed urea composition produced by the method comprising of mixing, heating and reacting the following components;
(A) urea, in the amount of 50-100 parts by weight;
(B) water, in the amount of 10 to 40 parts by weight;
(C) salt forming compound, in the amount of 0 to 400 parts by weight;
(D) filler, in the amount of 0 to 300 parts by weight;
components A and B are first mixed then heated to up to 120 degrees C. at ambient pressure for 0.1 to 3 hours thereby producing a partially hydrolyzed urea,
then component C is added, mixed, heated at 100 to 120 degree C. at ambient pressure for 0.1 To 3 hours thereby producing a partially hydrolyzed salt then component D is added and mixed thereby producing a partially hydrolyzed urea composition.

13. The method of claim 12 wherein the partially hydrolyzed urea is a potassium partially hydrolyzed urea salt of phosphorous acid.

14. The product produced by the method of claim 12-13.

15. A fertilizer, fungicide and insecticide composition consisting of partially hydrolyzed urea produced by adding 50-100 parts by weight of urea to 1040 parts by weight of boiling water then continuing to heat the mixture at 100 to 120 degrees C. at ambient pressure for 0.1 to 3 hours thereby producing partially hydrolyzed urea.

16. The fertilizer, fungicide and insecticide composition of claim 15 wherein the partially hydrolyzed urea is reacted with phosphorous acid then reacted with potassium hydroxide until the pH is 6-8.

17. The fertilizer, fungicide and insecticide composition of claim 15 wherein the partially hydrolyzed urea is reacted with a mixture of organic phosphite and phosphoric acid then reacted with ammonia until the pH is 5-8.

18. The fertilizer, fungicide and insecticide composition of claim 15 wherein the filler is tetrapotassium pyrophosphate.

19. The method of claim 12 wherein the salt forming compound is selected from the group consisting of phosphorus oxyacids, boron oxyacids, sulfur oxyacids, boron-phosphates, phosphates, phosphorous acid, hypophosphorous acid, polyphosphorous acid, polyhypophosphorus acid, ammonium salts of phosphorous acids, polyphosphates of ammonia, alkali metal hydrogen phosphates, alkaline earth metal hydrogen phosphates, phosphates of amines, polyamines, amino compounds, thioureas, alkyanolamines, boric acid and its salts and their derivatives, organic phosphorus compounds and their salts, halogenated organic phosphorus compounds, their salts and their derivatives, organic acids, nitrogen containing salts of boron-phosphate oxyacid, phosphoric acid, pyrophosphoric acid, triphosphoric acid, metaphosphoric acid, phosphorous acid, hydrophosphorous acid, phosphinic acid, phosphinous acid, phosphine oxide, phosphorus trihalides, phosphorus oxyhalides, phosphorus oxide, mono-metal hydrogen phosphates, ammonia dihydrogen phosphate, bromated phosphates, alkali metal dihydrogen phosphate and halogenated phosphate-phosphite and their halides and acids, alkylchlorophosphines, alkyl phosphines, alkyl phosphites, dialkyl hydrogen phosphites, dialkyl alkyl phosphonates, trialkyl phosphites, organic acid phosphates, organic diphosphonate esters, aryl phosphites, aryl hydrogen phosphates, halogenated phosphonates esters, alkali metal containing compounds, alkaline earth metal containing compounds, ammonia, amines, polyamines, amino compounds and mixtures thereof.
